(19) United States
(12) Patent Application Publication
(10) Pub. No.: US 2023/0351282 A1
(43) Pub. Date: Nov. 2, 2023

(54) SYSTEMS AND METHODS FOR PREPARING AND OPTIMIZING A PROJECT PLAN

(71) Applicant: EndFirst Plans Inc., Halifax (CA)

(72) Inventors: Alan David Uren, Halifax (CA); Semen Evgenievich Kudriavtsev, Ukhta (RU); Wayne Shaw Greenwood, Canterbury (AU)

(73) Assignee: EndFirst Plans Inc., Halifax, NS (CA)

(21) Appl. No.: 18/129,625

(22) Filed: Mar. 31, 2023

Related U.S. Application Data
(63) Continuation-in-part of application No. PCT/CA2022/051433, filed on Sep. 27, 2022.
(60) Provisional application No. 63/252,261, filed on Oct. 5, 2021.

(51) Int. Cl. G06Q 10/0631; G06Q 10/10; G06F 3/0486

(52) U.S. Cl. CPC G06Q 10/06312; G06Q 10/103; G06Q 10/06316; G06F 3/0486

(57) ABSTRACT

A system and method for preparing and optimizing a project plan is described. The system includes various modules including a database, a user interface, a cost analyzer, a resource conflict analyzer, a critical path analyzer, a calendar calculator, and a plan editor. The various analyzers and plan editor perform automatic calculations and analyses when preparing a project plan to optimize the project plan in terms of start and end dates, resource use and costs, and to reduce or eliminate errors in the project plan in terms of time conflicts and incorrect task dependencies.

### CROSS-REFERENCE TO RELATED APPLICATIONS

The present disclosure is a continuation-in-part of Intern. Appl. No. PCT/CA2022/051433, filed on Sep. 27, 2022, entitled “Systems and Methods for Preparing and Optimizing a Project Plan”, (Attorney Docket No. P3962WO), which claims priority from U.S. Provisional Appl. No. 63/252,261, filed on Oct. 5, 2021, entitled “Systems and Methods for Preparing and Optimizing a Project Plan”, (Attorney Docket No. P3962PR), herein incorporated by reference in their entireties.

### TECHNICAL FIELD

The disclosure relates to project planning, and more specifically to preparing and optimizing project plans.

### BACKGROUND

In the field of project management, a project manager or team typically plans and organizes a project by defining the necessary tasks that are needed to complete the project, any logical relationships between the tasks, a schedule for the tasks, and any associated resource requirements and costs. There are a number of software programs that are often used to assist with the creation, display and management of the project.

The use of software programs in project management should make planning easier and less prone to errors. However, this is often not the case, and many project plans include errors that can catastrophically derail the timeline and costs of a project.

The subject disclosure is directed at a system and method for preparing and optimizing a project plan that minimizes errors in the plan and optimizes the project plan with regard to the timeline, use of resources, and associated costs.

### SUMMARY

In accordance with the disclosure, there are provided systems and methods for preparing and optimizing a project plan.

In accordance with one aspect, there is provided a method for preparing and optimizing a project plan comprising the steps: providing a display having a project timeline and a project end date graphic on the timeline at a project plan end date; inputting a first task and a first task duration; dynamically calculating a first task start date and a first task end date based on the first task duration and the project plan end date and displaying a first task graphic on the project timeline at the first task start date; inputting a second task and a second task duration, wherein the second task is dependent on the first task; dynamically calculating a second task start date and a second task end date based on the second task duration and the first task start date and/or the first task end date, and displaying a second task graphic on the project timeline at the second task start date; dynamically re-calculating the project plan start date equal to an earlier of the first task start date and the second task start date, and displaying the project plan start date graphic on the project timeline at the re-calculated project plan start date; wherein the first and second task are collectively referred to as dependent tasks comprising a successor task and a predecessor task; and dynamically displaying a dependent task linking graphic connecting the first task graphic and the second task graphic, wherein the dependent task linking graphic indicates task duration of the predecessor task and any float between the dependent tasks.

In some embodiments, each task graphic has a task graphic start position in the project timeline representing the task start date, and a task graphic end position that is a predetermined distance from the task graphic start position regardless of the task end date, wherein the predetermined distance is the same for each task graphic.

In some embodiments, the method further comprises determining whether the predecessor task end date is later than the predecessor task graphic end position; determining whether the successor task graphic start position is later than the predecessor task end date; if yes to both of the above, displaying the dependent task linking graphic in the project timeline between the first task graphic and the second task graphic as a first segment having a first style between the predecessor task graphic end position and the predecessor task end date to represent the predecessor task duration, and a second segment having a second style between the predecessor task end date and the successor task graphic start position to represent the float between the dependent tasks. The dependent task linking graphic may be in the form of a line.

In some embodiments, the method comprises for dependent tasks, dynamically calculating and displaying whether there is a time conflict between the end date and/or the start date of the dependent tasks.

In some embodiments, the method comprises, in response to a user moving one of the task graphics in the project timeline to a new position: dynamically calculating a new start date and a new end date for the moved task; dynamically calculating whether there is a time conflict between the new start end date, the new start date, and any other tasks that are dependent tasks with the moved task; if there is a time conflict, dynamically moving the moved task graphic back to its previous position where there was no time conflict; and if there is no time conflict, displaying the moved task graphic at the new start date.

In some embodiments, the method further comprises, in response to a user updating a task start date from an original start date to a proposed start date, dynamically calculating whether the proposed start date creates any time conflicts between dependent tasks, and if yes, updating task start dates for dependent tasks to prevent time conflicts and displaying the task graphics at the updated task start dates.

In some embodiments, in response to a user moving a predecessor task graphic or a successor task graphic in the timeline, dynamically calculating any change in float between the dependent tasks and displaying the changed float in the dependent task linking graphic.

In some embodiments, the method further comprises, in response to a user adding a task in the timeline dynamically calculating a new project plan start date to be equal to an earliest start date of all the tasks and displaying the start date graphic in the project timeline at the new plan start date.

In some embodiments, the method further comprises, in response to a user adding or editing a resource needed to implement the project plan and associating the resource with one or more of the tasks, calculating any conflicts in use of the resource for each time interval in the project timeline and displaying any calculated resource conflicts.

In some embodiments, the method further comprises, in response to a user performing a trigger action, prompting the user to verify dependencies between dependent tasks. The trigger action may comprise any one or combination of the following: selecting an advancing graphic to advance building of the project plan; adding or editing a task; and selecting a verification initiation graphic. The prompting of the user may be an audio prompt.

In some embodiments, the method further comprises, wherein in response to a user inputting a budget and a cost associated with each task, calculating and displaying a running total of the budget in the timeline, and wherein in response to a user adding, deleting, editing or moving a task in the timeline, dynamically updating the running and comparing it to a budget.

In some embodiments, after the first task is input, one or more predecessor tasks dependent on the first task are suggested and displayed to a user based on a database of possible tasks. An artificial intelligence (AI) system may determine the one or more suggested predecessor tasks. Upon a user accepting at least one of the one or more suggested predecessor tasks, the at least one accepted task is input as the second task.

In some embodiments, there is provided a method for analyzing and optimizing an existing project plan, comprising: providing a display having a project timeline; inputting a plurality of tasks and task properties from the existing project plan into the timeline, wherein at least some of the tasks are dependent tasks comprising predecessor tasks and successor tasks, and wherein the task properties comprise task duration, task start date, task end date, and task dependencies; displaying each task on the timeline with a task graphic located at the task start date; displaying linking graphics between dependent tasks, wherein the linking graphics display the task duration of the predecessor task and any float between the dependent tasks; and calculating whether there are any time conflicts between the dependent tasks and displaying any time conflicts.

The method may further comprise calculating new task start dates and end dates for the plurality of tasks to clear any time conflicts and displaying the task graphics at the new start dates; and calculating and displaying any changes in the linking graphics between dependent tasks.

In some embodiments, there is provided a system for preparing and optimizing a project plan comprising for carrying out one or more of the above methods. The system may comprise a memory comprising a database for storing data; a display configured to display a project timeline and a project end date graphic positioned at a project end date on the project timeline; a graphical user interface controller configured to allow a user to input data; and a processor configured to carry out any of the above methods.

In some embodiments, there is provided a system for analyzing and optimizing an existing project plan, comprising a memory comprising a database for storing data; a display configured to display a project timeline; a graphical user interface controller configured to allow a user to input data; and a processor configured to: in response to a user inputting a plurality of tasks and task properties from the existing project plan into the timeline, wherein at least some of the tasks are dependent tasks comprising predecessor tasks and successor tasks, and wherein the task properties comprise task duration, task start date, task end date, and task dependencies: displaying each task on the timeline with a task graphic located at the task start date; displaying linking graphics between dependent tasks, wherein the linking graphics display the task duration of the predecessor task and any float between the dependent tasks; and calculating whether there are any time conflicts between the dependent tasks and displaying any time conflicts. The processor may be further configured for calculating new task start dates and end dates for the plurality of tasks to clear any time conflicts and displaying the task graphics at the new start dates; and calculating and displaying any changes in the linking graphics between dependent tasks.

In some embodiments, the processor is further configured to: after the first task is input, suggest and display one or more predecessor tasks dependent on the first task based on a database of possible tasks. An artificial intelligence (AI) system may determine the one or more suggested predecessor tasks. The processor may be further configured to: upon a user accepting at least one of the one or more suggested predecessor tasks, inputting the at least one accepted task as the second task.

### BRIEF DESCRIPTION OF THE DRAWINGS

Various objects and features of the disclosure will be apparent from the following description of particular embodiments of the disclosure, as illustrated in the accompanying drawings. The drawings are not necessarily to scale, emphasis instead being placed upon illustrating the principles of various embodiments of the disclosure. Similar reference numerals indicate similar components.

FIG. 1 is a block diagram of one example of the architecture of a system for building and optimizing a project plan.

FIG. 2 is an image of a user interface showing a project plan built and optimized with the system.

FIG. 3 is an image of a user interface showing a starting point for building a project plan with the system.

FIG. 4 is an image of a user interface showing a task property box for adding a new task to the project plan.

FIG. 5 is an image of a user interface showing a first task graphic added to the project plan.

FIG. 6 is an image of a user interface showing two task graphics added to the project plan.

FIG. 7 is an image of a user interface showing a project plan having a number of dependent tasks.

FIG. 8 is an image of a user interface showing a project plan in the process of being built and optimized.

FIG. 9 is an image of a user interface showing a project plan with a time conflict between two dependent tasks.

FIG. 10 is an image of a user interface showing the project plan of FIG. 9 where the time conflict has been corrected.

FIG. 11 is an image of a user interface showing the project plan of FIG. 9 where the time conflict has been corrected and extra float has been added between dependent tasks.

FIG. 12 is an image of a user interface showing a project plan with a resource conflict error indicator.

FIG. 13 is an image of a user interface showing a project plan where a cost analyzer has been run to provide cost information for the plan.

FIG. 14 is a diagram of an example of a system architecture for suggesting new tasks using an artificial intelligence (AI) system.

### DETAILED DESCRIPTION

Preparing a project plan can be a complex and time-consuming task, particularly for a large project having hundreds or thousands of tasks. It is quite common for there to be errors in the project plan, for example the omission of a dependency link between tasks or the omission of a task itself. Such errors can be costly and can derail a project from being completed on time and/or on budget. Experienced and skilled project planners are often able to minimize or avoid errors in the planning phase, but they are not always perfect. In addition, unexpected occurrences almost always occur while executing a project plan, which lead to necessary changes in the project plan. Making changes to a project plan can be time-consuming, as it often involves editing various tasks, dependency links, task start and end dates of tasks, resource allocation, and more.

The current software programs that are available for project planning have a number of drawbacks. One of the drawbacks is that they do not provide a visual display of the project plan that is easy to read, understand and manipulate. The way that the project plan is created in the current software programs also leads to a high probability of errors and omissions. Some programs, like Microsoft® Project and Primavera P6™ use a Gantt chart (bar chart) based on a spreadsheet of rows and columns to display a project plan. Each task occupies a single row with a variable length bar indicating the task's duration, with a variable length dependency line representing the float connecting one task to another. The multiple rows in such programs result in very tall layout for a project plan that is difficult to view and understand, particularly for large projects with many tasks. The display cannot accommodate the data associated with the tasks (for example, task start date, task end date, task duration, task resources, task completion, etc.), so it is listed in a separate table. This requires a user to continually go back and forth between the displayed Gantt chart and the data table, which is not efficient nor easy to do.

Some project management software programs use diagrams instead of task bars to create a visual of the project plan, showing dependency links between various tasks. These diagrams are limited in that they are not easy to understand and do not clearly display the timescale of the plan or provide time information for the tasks (e.g. start date, end date, duration) or the float between dependent tasks. They only provide limited details and data associated with the tasks.

Project management software also typically has a user build a plan by adding tasks sequentially from start to finish. This method of project plan creation does not easily allow for concurrent tasks that occur in parallel to be identified and added.

This disclosure is directed at systems and methods that provide improvements in preparing and optimizing project plans. The disclosure provides for the efficient preparation of a project plan in a manner that minimizes errors and optimizes the plan in terms of timing, costs and resource allocation. The disclosure provides a visual representation of the project plan in a manner that is easy and intuitive for a user to build, read, understand and edit the project plan. Users do not need to scan back and forth between a visual display and a data table, but instead can easily and intuitively view and access all the data associated with a task in the visual display. A user can easily edit the project plan using the visual display, instead of having to enter data in a separate table. The display clearly shows the timeline of the project plan, including task start dates, task end dates, task duration and available float between dependent tasks. The manner in which the plan is built, from the end to the start of the plan, provides a more accurate project plan that has a lower incidence of errors and omissions.

### Definitions

The following definitions may be useful in understanding the disclosure:

“Constraint” refers to something that imposes a limit or restriction on a task. Types of constraints include: as soon as possible (ASAP), as late as possible (ALAP), start no earlier than, start no later than, finish no later than, finish no earlier than, start on date, and finish on date.

“Critical Path” refers to a path connecting dependent tasks from the project start date to the project end date in a project plan that has the least amount of float. There can be multiple critical paths in a project plan.

“Critical Task” refers to a task that is on the critical path. If there is a change in the start or end date or duration of a critical task, it will almost always impact the project end date.

“Deliverable” refers to an element of output within the scope of the project. A deliverable can be internal, where the work is undertaken within the project organization and is included in the project budget, or external, where the work is done outside of the project organization (e.g., by a client, customer or stakeholder) and is outside of the project budget.

“Dependency” refers to a relationship between tasks comprising a predecessor task and a successor task, which are referred to as “dependent tasks”. The predecessor task controls the start date or end date of the successor task. There are four main types of task dependencies:
Finish to Start (FS): A successor task cannot start until a predecessor task has finished. This is the most common dependency between tasks in a project plan.
Start to Start (SS): A successor task cannot start until a predecessor task has started.
Finish to Finish (FF): A successor task cannot finish until a predecessor task has finished.
Start to Finish (SF): A successor task cannot finish until a predecessor task has started.

“Float” refers to the amount of time available between dependent tasks having a finish-to-start dependency in which the predecessor task can be delayed without impacting the start date of the successor task. “Total float” is the amount of float along an entire task line connecting dependent tasks from the project start date to the project end date.

“Lag” refers to a required delay in time before a successor task can start.

“Lead” refers to the amount of time that a successor task can start before a predecessor task has finished.

“Milestone” refers to a significant point in a project plan that is often used to signify a change or stage in development. The project start date and end date are milestones. Milestones may also include a need for external review, a budget check, or a deliverable.

“Project Plan” is a formal document used to guide both project execution and project control. The primary uses of the project plan are to document planning assumptions and decisions, facilitate communication among project stakeholders, and document approved scope, cost, and schedule baselines.

“Project Timeline” is the chronological order of tasks and milestones within the project plan from the project start date to the project end date.

“Pull Planning” refers to a method for preparing a project plan that starts at the project end date and moves backwards toward the project start date. It contrasts to “push planning”, which a common method of project planning that develops a plan from the project start date moving forward to the project end date.

“Resource” refers to an asset that is required to execute a project plan, such as a person, equipment, or materials.

“Task” is a work item or activity with a specific purpose related to the larger goal. It is a necessary step to complete the project.

“Task Duration” is the time estimated to complete a task and is the time difference between the task start date and the task end date.

Various aspects of the disclosure will now be described with reference to the figures. For the purposes of illustration, components depicted in the figures are not necessarily drawn to scale. Instead, emphasis is placed on highlighting the various contributions of the components to the functionality of various aspects of the disclosure. A number of possible alternative features are introduced during the course of this description. It is to be understood that, according to the knowledge and judgment of persons skilled in the art, such alternative features may be substituted in various combinations to arrive at different embodiments of the present disclosure.

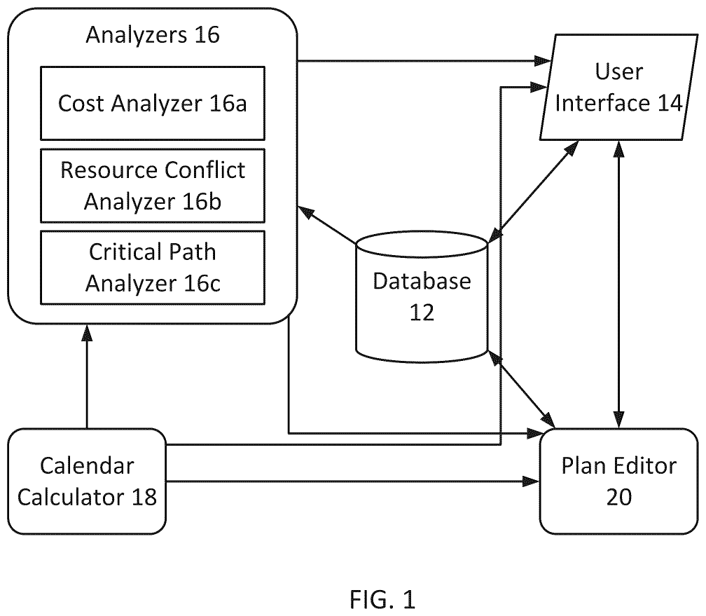

FIG. 1 is a block diagram of one example of the architecture of a computer application in accordance with the disclosure. The computer application may comprise various modules including a database 12, a user interface 14, a calendar calculator 18, a plan editor 20, and one or more analyzers 16, including a cost analyzer 16a, a resource conflict analyzer 16b, and a critical path analyzer 16c. The computer application may be executed on a computer device (not shown), which may comprise one or more computer processors, memories and displays. The computer device may be a desktop computer, laptop computer, tablet, smartphone, personal digital assistant, and the like. The display may comprise one or more of a monitor, LCD display, LED display, projector, and the like.

The computer system may be a cloud-based system in which the computer application is in communication with other devices via a network such as Ethernet, Internet, 3G/4G/5G wireless mobile telecommunications network, and/or the like via suitable wired and/or wireless communication means.

One or more of the modules may be run by one or more processors to carry out the instructions associated with the modules, including the calendar calculator, plan editor, cost analyzer, resource conflict analyzer and critical path analyzer.

The user interacts with the computer application via the user interface 14, which may include a user interface controller. The user interface controller may include one or more input modules for a user to input data, such as a touch-sensitive screen, tough-sensitive whiteboard, trackball, computer mouse, touch-pad, or other human interface device. The user input controller may be physically integrated as part of the computer device, part of a display device separate but coupled to the computer device, and/or be separate but coupled to the display and computer device using wired or wireless means. The computing device may also comprise one or more other inputs such as keyboards and microphones, and/or one or more other outputs such as speakers.

The plan editor 20 may be part of the processor which edits the project plan in response to user input and/or calculations made by a processor on the computer display to prepare and optimize a project plan.

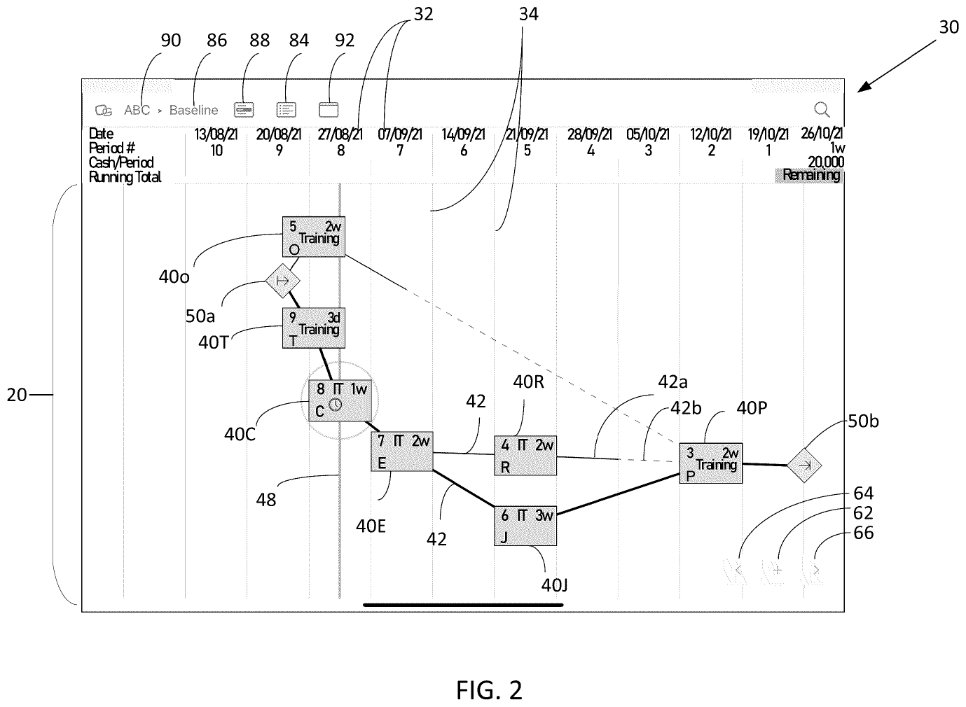

FIG. 2 illustrates the user interface showing an example of a project plan 30 that has been prepared and optimized using the computer application. The project plan includes the following visual representations of various features of the project plan:
1. The timeline is represented by dates 32 and guidelines 34 dividing the timeline into designated time increments, which in this case are one-week increments.
2. The tasks are represented by task graphics 40 which have letters to indicate which tasks they refer to, i.e. tasks P, R, O, J, E, C, T), which in this example are rectangular shaped boxes. The task graphics may cover a fixed length on the timeline, regardless of the task duration. Each task graphic may be the same size and shape, regardless of task properties. For example, the width of the illustrated task boxes is the same as the distance between the timeline guidelines 34, representing one week.
3. The milestones are represented by milestone graphics 50a, 50b, which in this example are diamond shaped boxes. Milestones include a project start date graphic 50a and a project end date 50b. The milestones may be represented by other shapes and sizes of graphics. For example, the graphic may be a vertical line or bar that extends along the height of the project plan user interface. Other milestones can be added at intermediate points in the project plan.
4. Dependent tasks are connected using dependency links 42, which are represented by graphics (e.g., lines) connecting a predecessor task to a successor task. The dependency links in FIG. 2 are all finish-to-start dependencies and are illustrated by different graphics to represent 1) the task duration of the predecessor task and 2) the float between the dependent tasks. In this example, the task duration is shown by solid line section 42a and the float between dependent tasks is shown by a dashed line section 42b. In FIG. 2, task R has a task duration of two weeks, indicated by “2w” in the top right corner of the task box. Since the task boxes are sized to have a width that represents one week on the timeline, the solid line section 42a of the dependency link extends a further one week along the timeline. The remaining length of the dependency link is represented by a dashed line section 42b to indicate that this portion of time between predecessor task R and successor task P is float. If there is no float between dependent tasks, such as between tasks E and R, the dependency link 42 only has a solid line portion. Other types of graphical representations may be used to distinguish between the task duration and the float between dependent tasks.
5. The critical path in the project plan is represented visually in the project plan by including a graphic indicator. The graphic indicator may be shown as part of the dependency links, the tasks in the critical path and/or in another manner. For example, the dependency links along a critical path may be shown in a different color than dependency links not part of a critical path. FIG. 2 illustrates the critical path dependency links 42 as having a thicker line than dependency links not along the critical path. In this example, the critical path goes from the start milestone 50a to task 40T, 40C, 40E, 40J, 40P to end milestone 50b.
6. A dateline 48 is a graphical indicator that indicates the current date and time on the project plan. In the example in FIG. 2, the dateline is shown as a vertical line on the timeline. It moves from left to right automatically as time progresses and can be used during plan execution as a visual indicator to assess if tasks are on schedule or not.

The above-described and illustrated representations are one example of how the project plan can be displayed. Modifications can be made to the graphics and layout of the project plan.

### The Modules

The modules illustrated in FIG. 1 carry out various functions of the computer application. The database 12 stores the data associated with the application, which may include the tasks, milestones, constraints, resources, and their associated properties. A user may change the data via the user interface 14 and/or the plan editor 20, which are shown in FIG. 2.

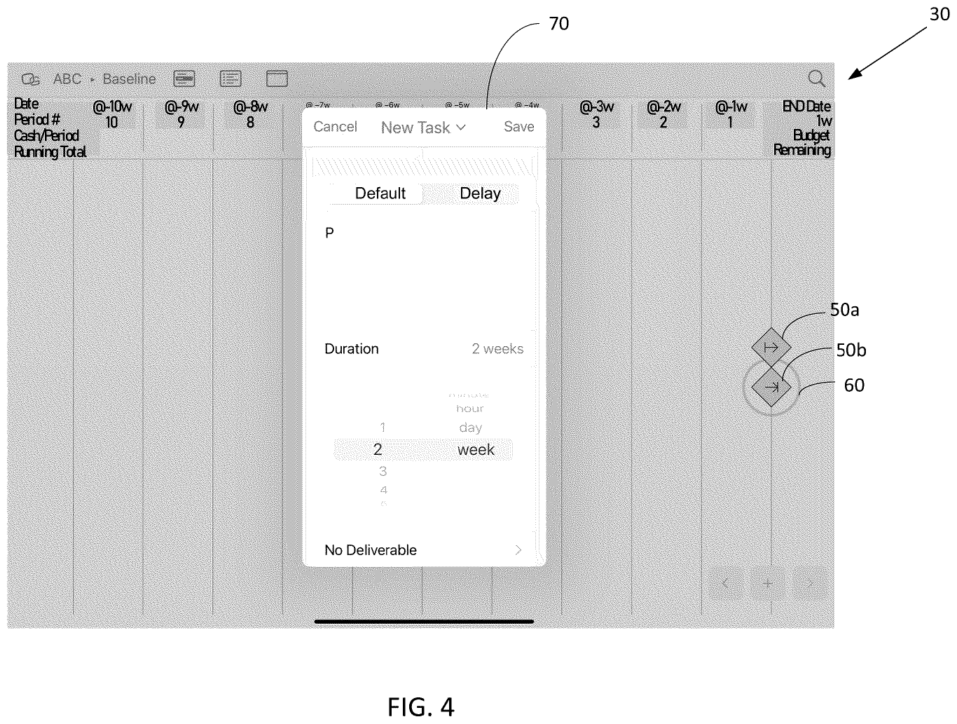

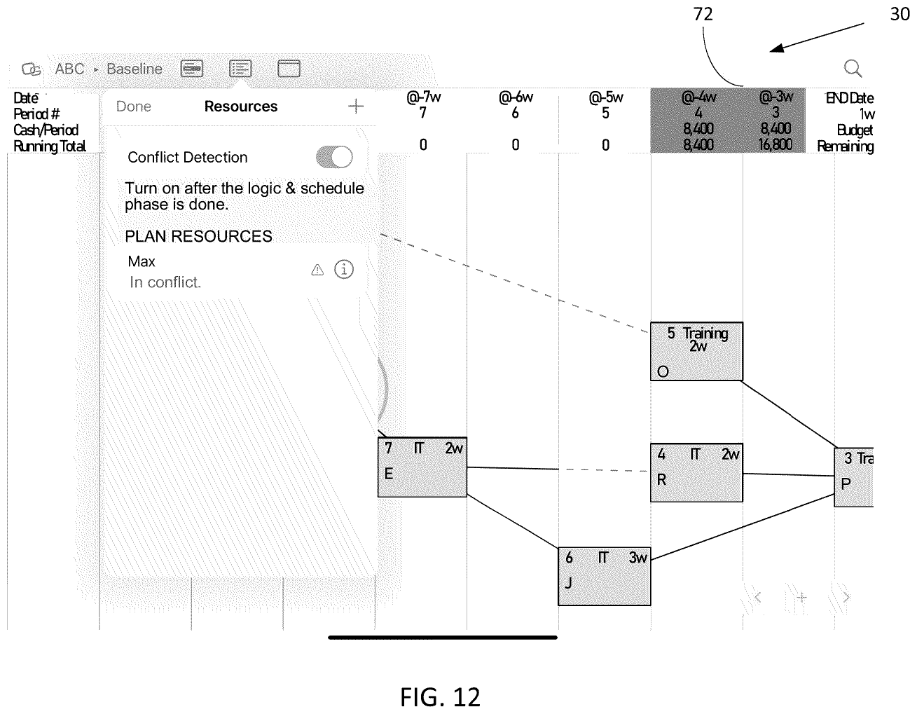

The user interface 14 includes several buttons 84, 86, 88, 90, 92, 62 that when selected may open an input window or menu where a user can input or change data. The input windows/menus may include the following:
An add object button 62 which when selected opens an add task window 70 (see FIG. 4) where a user can input a task and its associated properties including task name, duration, start date, end date, resources, constraints, and more.
A resource menu 84 (see FIG. 12) where a user can add one or more resources and their associated properties, including resource name, description, type (e.g. human, equipment, facilities), availability limit (e.g. by % usage, age or number count), and cost rates (e.g. fixed cost, per hour cost, or cost per use).
A deliverable menu 88 where a user can input one or more deliverables and their associated properties, including deliverable name, description, color code and whether the deliverable is an inclusion or exclusion.
A plan view menu 92 where a user can choose how the plan is viewed (e.g. fit to window, zoom level) and whether certain elements are on or off (e.g. plan verification, critical path, guidelines).

The plan editor 20 is shown in FIG. 2 and is the timeline where a user prepares and optimizes the plan by adding and moving task graphics 40 (e.g., through dragging and dropping task graphics) and connecting task graphics with dependency links 42 (e.g., by dragging a dependency link from one task graphic to another).

The analyzers 16 includes one or more analyzers for carrying out various analyses required for preparing and optimizing the project plan, which may include the cost analyzer 16a, the resource conflict analyzer 16b, and the critical path analyzer 16c. A change in data through the user interface or plan editor may trigger the analyzers 16 to carry out their analyses.

The calendar calculator 18 may be used for any date calculations required when preparing and optimizing the project plan, including start dates, end dates and durations for tasks and milestones. For example, the calendar calculator may convert a task position in the plan editor to a start date and/or end date. The calendar calculator may also convert a task duration to actual time. The actual time depends on the work week configuration. For example, a work week could be set at 40 hours (8 hours a day×5 days a week), 168 hours (24 hours×7 days), or a custom configuration.

### Preparing and Optimizing a Project Plan

An example of the preparation and optimization of the project plan will now be described with respect to the operation of the system and FIGS. 2 to 13, which illustrate an embodiment of the user interface 14 and plan editor 20.

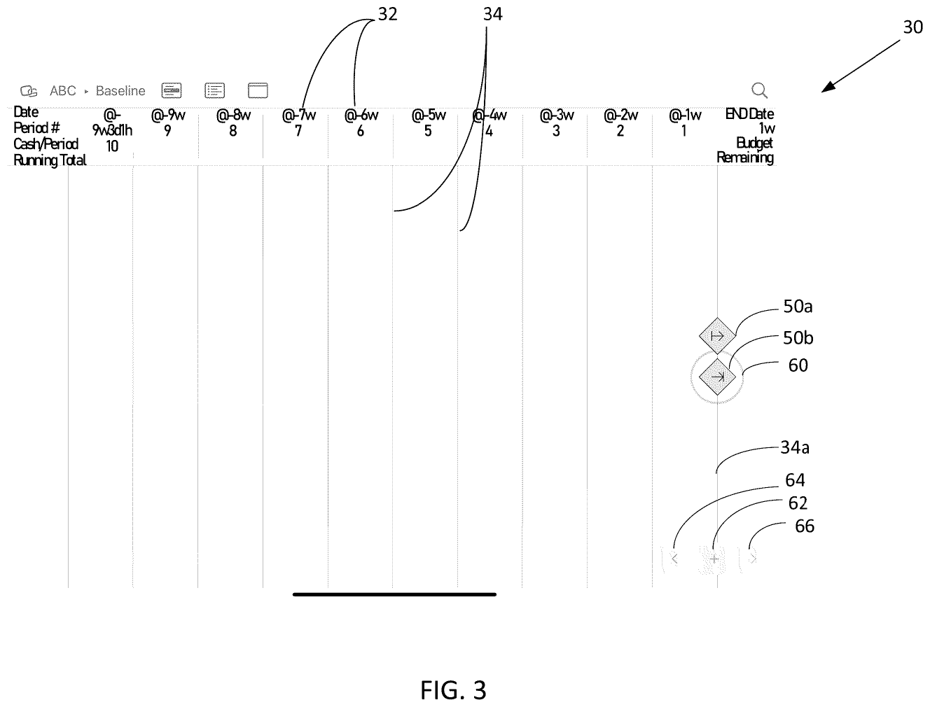

A blank project plan representing the starting point for preparing a project plan 30 is displayed in FIG. 3. The project end date milestone 50b and the project start date milestone 50a are positioned at the project end date at the latest date and guideline 34a in the project timeline (i.e., to the right side). The project plan is prepared by adding sequential tasks and parallel tasks, one at time and connecting dependent tasks, working backwards from the project end date, i.e., from right to left in the timeline, which is referred to as pull planning. The plan editor includes a variety of graphics and icons for receiving input from a user and displaying outputs, including:
An active task indicator 60, which is shown as a circle around the active task or milestone and indicates which task or milestone a user is working with.
An add object button 62, which is shown as “+”, and when pressed allows a user to input a new object such as a task or milestone as a predecessor task to the active task or milestone.
An advance button 64, which is shown as “<”, and when pressed moves the active task indicator 60 to the next task in the sequence, working backwards from the end date (i.e., right to left, and top to bottom to advance through sequential and parallel tasks).
A reverse button 66, which is shown as “>”, and when pressed moves the active task indicator 60 to the previous task in the sequence of tasks, working in the reverse order as the advance task button 64.

Referring to FIG. 4, to start preparing the plan, a user inputs a first task P in the user interface with an add task window 70, with task P being added as a finish-to-start dependent task from the plan end date. Task P is added by selecting the add object 62 button, which creates the new task in the plan editor as a predecessor task to the active task or milestone, which in this case is the end date milestone 50b shown by the active task indicator 60. Task properties are input in the add task window 70, including task name (P) and task duration, which is input as two weeks for task P. The user may choose which time units to input task duration in, such as minutes, hours, days, or weeks. The calendar calculator 18 converts the task duration into seconds and determines the task end date (T.end) of task P, which is the project end date in this case. The calendar calculator automatically calculates the task start date (T.start) by subtracting the task duration (T.duration) in seconds from the task end date, i.e., (T.start)=(T.end)−(T.duration).

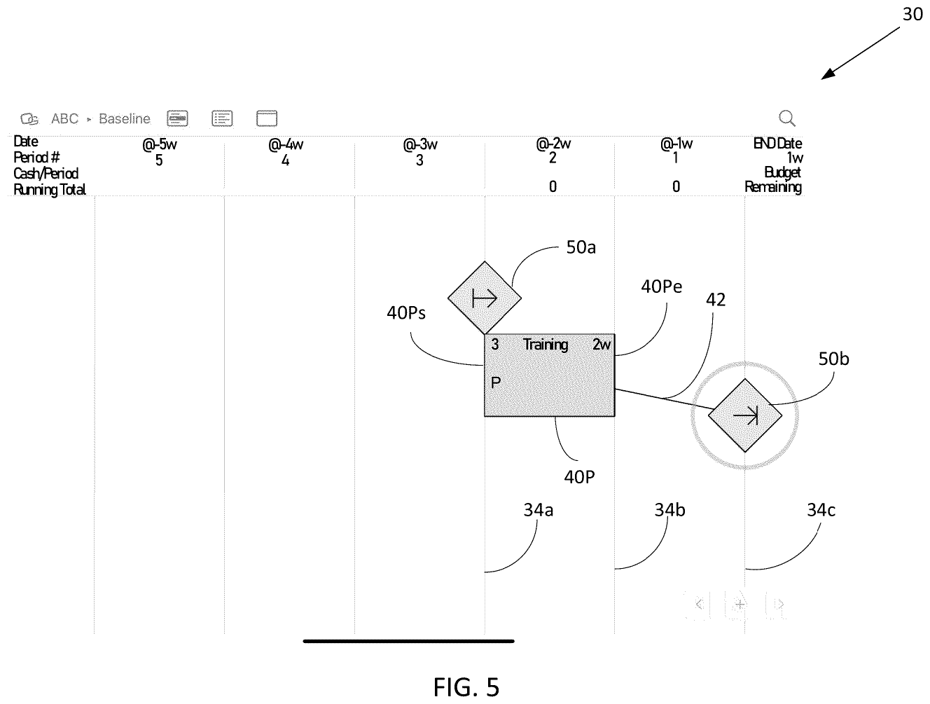

Referring to FIG. 5, when a task has been inputted, the plan editor 20 automatically adds a task graphic 40P in the user interface for first task P, as shown in FIG. 5. The task graphic 40P may have a predetermined size regardless of the task duration. The task graphic 40P has a task graphic start position 40Ps on the left side and a task graphic end position 40Pe on the right side. The plan editor positions the task graphic in the timeline so that the task graphic start position is located at the calculated task start date. The task graphic end position may be a fixed predetermined distance from the task graphic start position, which in this example is 1 week, shown by the task graphic stretching between guidelines 34a and 34b which represent a one-week period. This means that if the task duration of task P is shorter or longer than 1 week, the task graphic end position is still located at the same position in the timeline.

A dependency link 42 may be drawn by the plan editor between task 40P and the end milestone 50b since these are dependent tasks. To determine if and how the dependency link 42 is displayed, the plan editor determines if the task graphic end position 40Pe is less than the task P end date (i.e. whether the time represented by the task graphic 40P is less than the task duration). If no (meaning the time represented by the task graphic is equal to or less than the task duration), the plan editor abuts the task graphic end position against the project end date milestone. If yes, which it is in the example shown in FIG. 5, the plan editor draws a dependency link line 42 to connect the task graphic 40P to the project end date milestone 50b. The dependency link line 42 indicates the task duration of task P. In this example, the task duration of task P is two weeks. This is indicated visually to the user since the task graphic 40P plus the dependency link line 42 stretches across a two-week timespan on the project plan interface 30, from guideline 34a to guideline 34c.

When task 40P is added, the plan editor automatically calculates a new project start date to be equal to the task P start date, which is the earliest possible start date based on the tasks input into the project plan thus far. The plan editor automatically moves the project start date milestone 50a in the timeline to be located at the new project start date. The calculation of the new project start date and the movement of the project start date milestone is continues dynamically as more tasks are added to the project plan, with the project start date being equal to the earliest task start date in the project plan.

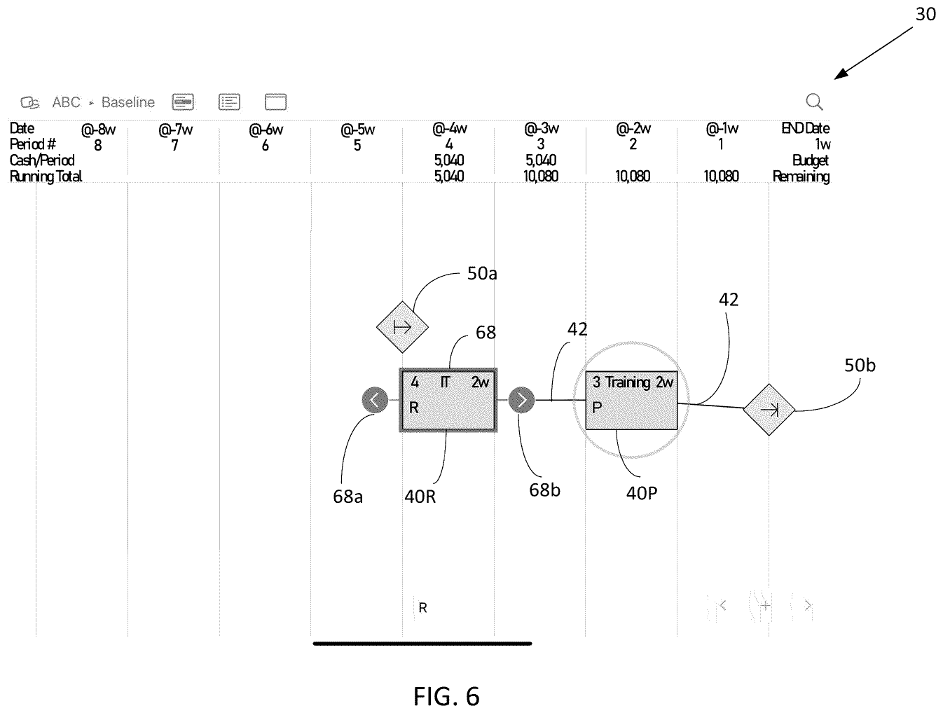

The project plan continues to be prepared by a user adding tasks and/or milestones in the same manner task P was added. FIG. 6 illustrates a second task R added in the timeline, shown by task graphic 40R, that is a predecessor task to task P as shown by the dependency link line 42 connecting the two tasks. Task R is illustrated in “select task mode”, shown by a selection indicator 68 which in this case is a colored border around the task graphic and two paddles 68a,b. The paddles can be manipulated by a user to connect task P to one or more other tasks to which task P has a dependency.

Whenever a new task is added to the project plan, it is added as a predecessor task to another task (or milestone), which is considered the successor task. The start date and end date of the new predecessor task are automatically determined by the plan editor, and the plan editor automatically adds the predecessor task to the appropriate position in the timeline based on these calculations in the same manner as described above for adding task P task. More specifically, upon adding a predecessor task having a task duration and a finish to start dependency with the successor task, the calendar calculator converts the predecessor task duration into seconds (P.duration), determines the predecessor task end date (P.end) to be equal to the successor task start date (S.start), and then calculates the predecessor task start date (P.start) based on this, i.e., (P.start)=(P.end)−(P.duration). The plan editor then automatically positions the predecessor task graphic in the timeline at the calculated start date (P.start), and determines how the link dependency will be displayed (as described previously with respect to task P).

The dependency between a predecessor task and a successor task can be a start-to-start dependency instead of a finish-to-start dependency. If this is the case, the predecessor task start date is calculated as (P.start)=(S.start)−(SS.lag), where P.start is the predecessor task start date; S.start is the successor task start date, and SS.lag is any lag time between the predecessor task and successor task.

If the dependency between a predecessor task and a successor task is a finish-to-finish dependency, the predecessor task start date is calculated as (P.end)=(S.end)+(FF.lead), where P.end is the predecessor task end date; S.end is the successor task end date, and FF.lead is any lead time between the predecessor task and successor task.

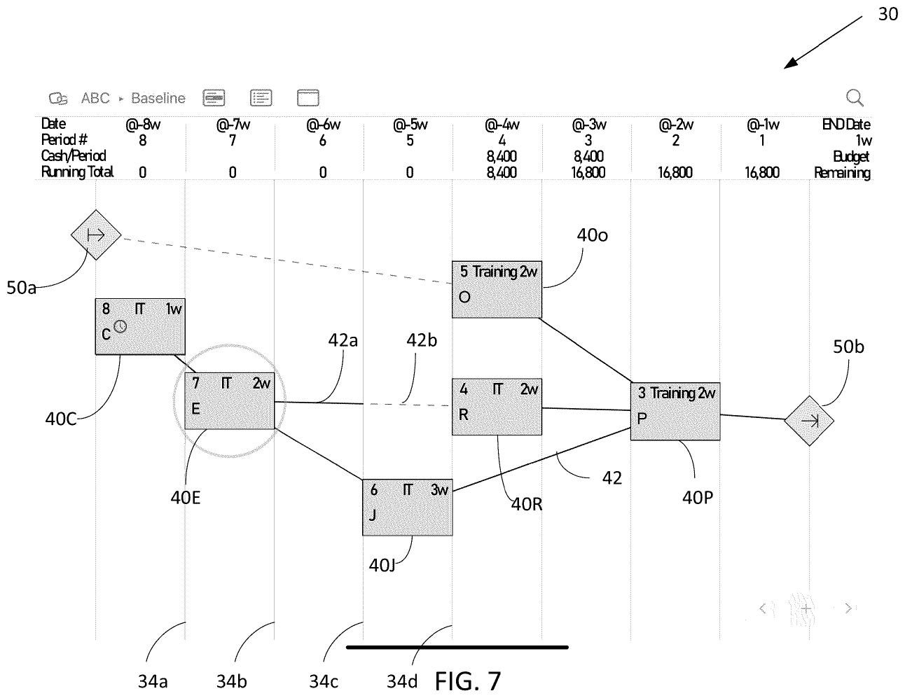

A task may have a dependency with one or more other tasks. As shown in FIG. 7, task E is a successor task to task C, and a predecessor task to task R and task J. During preparation of the project plan, any float between dependent tasks is automatically calculated by the plan editor and displayed with the dependency link line connecting dependent tasks. In the illustrated example, the dependency link line includes a first graphical representation, which in this example is a solid line 42a, to indicate task duration of the predecessor task, and a second graphical representation, which in this example is a dashed line 42b, to indicate the float between the dependent tasks. For example, the dependency link line between task 40E and task 40R illustrates a solid line segment 42a representing a time of one week (i.e., it extends between two guidelines 34b and 34c, each guideline represents one week in the timeline), meaning task 40E has a task duration of two weeks, which is the time covered on the timeline of the task graphic for task 40E (which extends between guidelines 34a and 34b, thus representing one week duration) plus the solid segment 42a of the dependency link line. The remaining segment of the dependency link line is shown as a dashed line segment 42b, representing the float between task 40E and task 40R, which in this case is a period of one week since it extends between guidelines 34c and 34d which represent one week of time. One week of float means that task 40E can be delayed up to one week without affecting the timing of dependent task 40R with respect to its start date and/or end date.

The plan editor uses the calendar calculator to aid in determining the display of a dependency link line, i.e., which segment is shown to represent task duration (i.e., using a solid line in this case) and which segment is shown representing float (i.e. using a dashed line in this case). The plan editor determines for each point in the line segment if it is earlier or later than the predecessor task end date (P.end). If the point is earlier than P.end, the line segment is solid. If the point is later than P.end, the line segment is dashed.

### Proactive Task Predecessor Identification System

In some embodiments, the system proactively suggests tasks to be added to the project plan. The system may use an AI system to determine which tasks should be suggested. For example, when a user inputs a task into the system, the system may compose a list of tasks that are dependent on the input task, including predecessor and successor tasks, referred to as a Task List. The system may also compose a Deliverable List, comprised of all the deliverables defined in the project plan. The Task List and Deliverable List are input into a Proactive Predecessor Identification System (PPIS) module. The PPIS accesses an AI system, which considers the Task List, the Deliverables List, and one or more databases to determine and suggest one or more dependent tasks for the project plan. The suggested tasks may be predecessor tasks to the most recently input task. The user may accept one or more of the suggested tasks, in which case the accepted task(s) are added to the project plan.

The PPIS module can be used to analyze if the Deliverable List is accurate based on the input tasks in the project plan. For example, after a task is input, the PPIS accesses an AI system which considers the Task List, the Deliverable List, and one or more databases to analyze whether the Deliverable List contains the information associated with the newly input task. If not, the PPIS suggests one or more amendments to the Deliverable List.

The PPIS module can be used for task verification. For example, when a user selects an active task in the project plan, and moves the cursor backward to the closest predecessor task, the PPIS may be prompted to verify the dependent tasks and the dependency links. For example, if several updates or alterations have been made to the plan, the user can select a task and activate the PPIS to verify that the current predecessors are accurate.

The one or more databases accessed by the AI system may include databases having common tasks and/or deliverables associated with project planning, and more specifically, common tasks and/or deliverables for project planning in certain fields, such as the construction field, IT, and healthcare. In the construction field, for example, the AI system may access a database having the latest building codes, such that the PPIS could verify that safety and performance standards are incorporated into the tasks.

The AI system may comprise an open pre-trained AI system. One example is ChatGPT™. In some embodiments, machine learning (ML) is incorporated into the AI system.

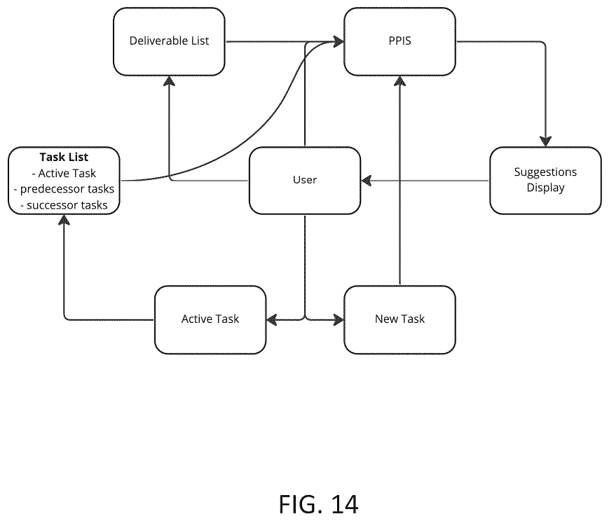

An example of the flow of the PPIS system is shown in FIG. 14. When the PPIS suggests a task or deliverable, it is displayed on the user interface, which is shown as the Suggestions Display in FIG. 14.

### Time Conflict Calculator

The project plan is optimized by automatically calculating any time conflicts between dependent tasks with regard to the start and end dates and alerting a user if a time conflict exists.

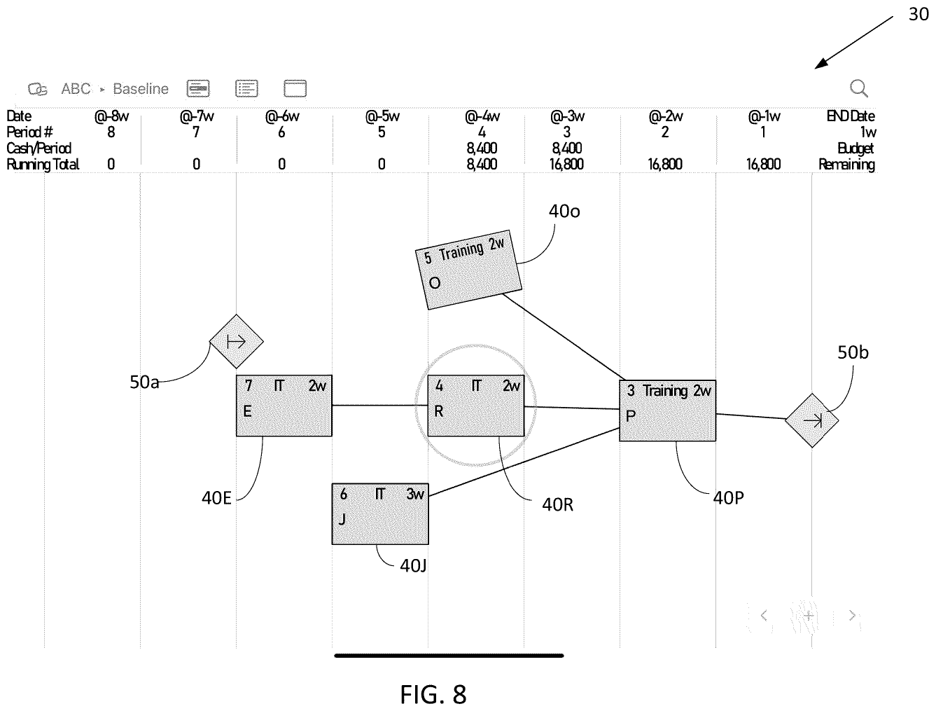

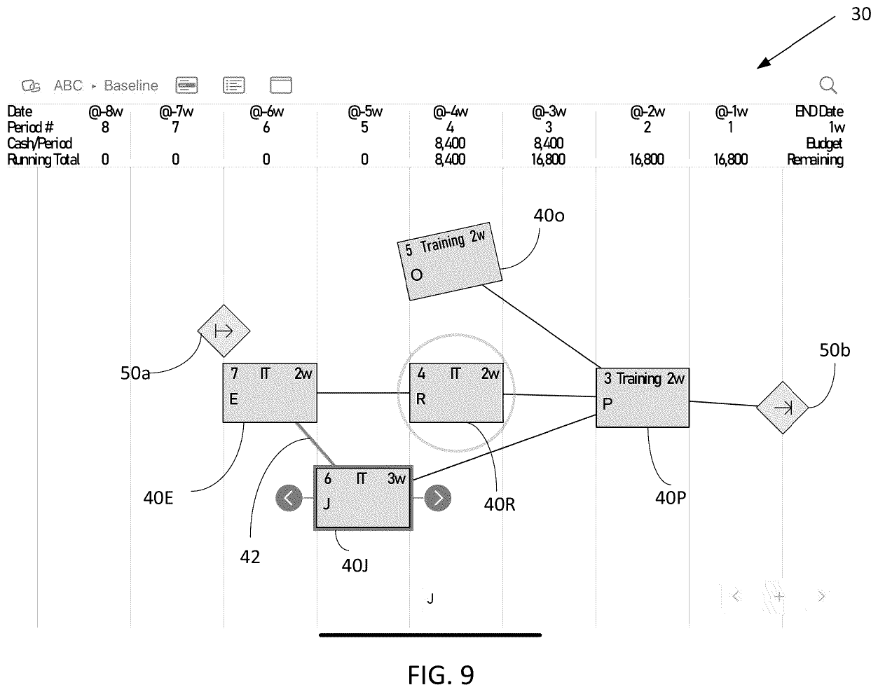

For example, FIG. 8 illustrates a project plan in the process of being built that includes task 40E which is a predecessor task having a finish-to-start dependency to task 40R. If task 40E is also a predecessor task to task 40J, a user indicates such in the plan editor by drawing a dependency link line from task 40E to task 40J (or vice versa from task 40J to task 40E). In this case the dependency is a finish-to-start dependency, meaning task 40E must finish before task 40J can start. The plan editor then determines any time conflict between the newly dependent tasks 40J and 40E by calculating if the predecessor task 40E end date (P.end) is less than successor task 40J start date (S.start). If yes, there is no time conflict. If no, there is a time conflict and the plan editor visually displays a graphical error indicator, as shown in FIG. 9. In this case, the graphical error indicator shows the dependency link line 42 between the tasks as a thicker line of a different color (e.g. red) compared to a normal dependency link line where there is no time conflict. The graphical error indicator may be shown in other visual ways.

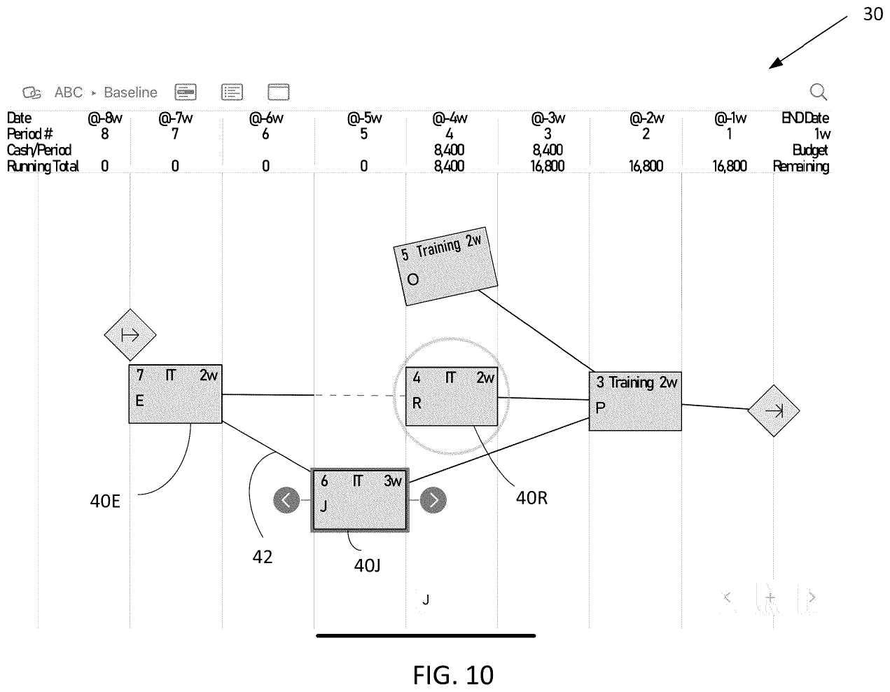

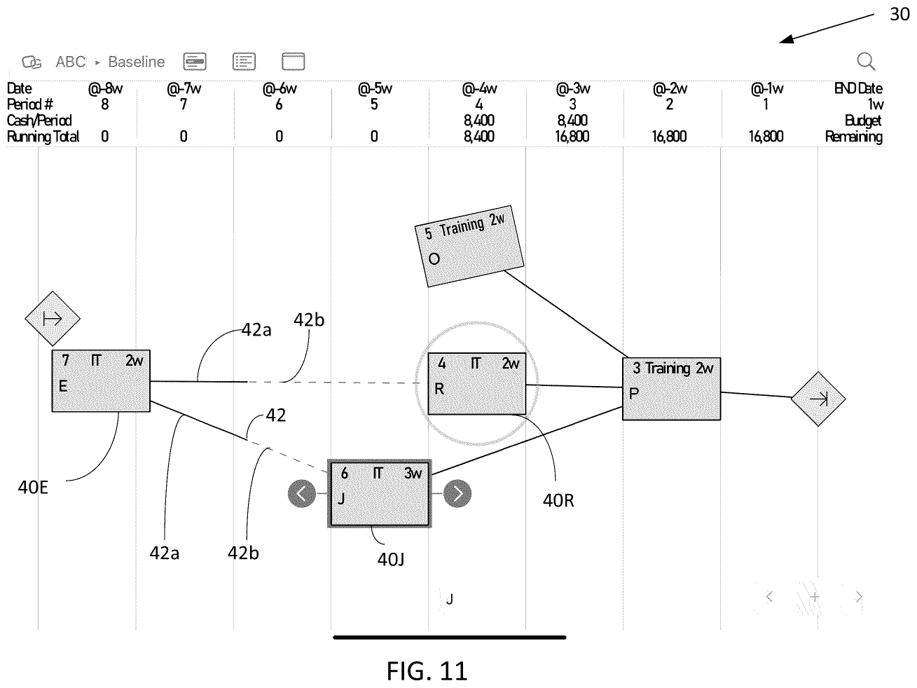

When a time conflict error is determined in the project plan, the error can be removed by changing the start date of the predecessor task and/or successor task. This can be done by a user inputting a change by moving the successor task graphic or predecessor task graphic to a different position in the timeline in the plan editor, such as by holding and dragging the task graphic. For example, in FIG. 9, the predecessor task graphic 40E can be moved to an earlier position in the timeline (to the left), which causes the start date to automatically updated to an earlier date in the database. Alternatively, the successor task graphic 40J can be moved to a later position in the timeline (to the right) to update the task to have a later start date. When the predecessor task or successor task has a new start date, the plan editor automatically runs the calculation to determine if there is a time conflict between the predecessor and successor task(s). If there is no time conflict, the plan editor removes the visual error indicator, such as shown in FIGS. 10 and 11 where the predecessor task graphic 40E has been moved to an earlier start date and there is no error indicator in dependency link 42. If there is a time conflict, the error indicator remains. Alternatively, the user may change the resources associated with a task to change the task duration and remove the time conflict error. For example, adding overtime to a resource, such as a human resource, can shorten the task duration but also increase the cost associated with the task.

When a user moves a task in the timeline to change the task start date, the plan editor also automatically calculates: 1) the task end date and updates it in the database; and 2) the change in float between dependent tasks and displays it visually (in this case as a dashed line segment in the dependency linking line). This optimizes the project plan because a user can see in real time as they're moving a task in the timeline, where the task should be positioned to have the minimal amount of float without any time conflict errors. For example, FIG. 10 illustrates the optimal position of task 40E where there are no time conflicts and there is the minimum amount of float between task 40E and dependent tasks 40R and 40J. Alternatively, FIG. 11 illustrates a position for task 40E that also does not create any time conflicts but includes unnecessary float between task 40E and dependent tasks 40R and 40J. More specifically, there is float 42b in the dependency link lines 42 between tasks 40E-40J and 40E-40R that is not necessary. A user may choose to have this additional float in the project plan, but if they want to optimize the plan to take the least amount of time as possible, they could move task 40E to a later start date, as shown in FIG. 10.

Once a task is in a position where there is no time conflict with dependent tasks, the plan editor may prevent a user from moving a task in the timeline. This prevents errors in the project plan as it is being built and edited. More specifically, if a user moves a task graphic in the timeline (e.g. by dragging the task to a new position), the plan editor automatically runs the time conflict calculation based on the new proposed start date to determine if any time conflicts exist with the dependent tasks. If yes, the plan editor may automatically move the task back to its original position with its original start date. If no, the plan editor may move the task to the new position with the new proposed start date, and the database is updated with the new start date for the task. For example, in FIG. 10, if a user tries to move task 40E from the position shown to a position with a later start date (i.e., moves it to the right), the plan editor would not allow this move because it creates a time conflict with task 40J since there is no float between tasks 40E and 40J. By contrast, if a user tries to move task 40E to a position with an earlier start date (i.e., moves it to the left), such as the position shown in FIG. 11, the plan editor would allow this move and update the dependency links 42 from task 40E to tasks 40J and 40R to add additional float between task E and tasks J and R. The plan editor also automatically calculates the new plan start date and moves the start date milestone 50a to the new start date position in the timeline.

### Bulk Optimization of Tasks

The project plan may be optimized to prevent time conflicts by moving and updated a plurality of tasks in response to one task being updated. This may be done using the following steps:
1) A user initiates a “Force Move” for a selected task in the plan editor.
2) The plan editor visually indicates the selected task, for example by drawing a thicker border around the selected task.
3) The user moves the selected task graphic to a new position in the timeline.
4) The plan editor determines for each task connected directly or indirectly to the selected task whether there is float or if float can be established based on the new position of the task, which represents a new start date and a new end date.
   a. If yes: the plan editor automatically updates the dependency link for the connected task to add or adjust float so there is no time conflict.
   b. If no: the plan editor automatically moves the connected task to a new position where there is no time conflict. This helps build and optimize the plan automatically and efficiently.

### Resource Analyzer

The project planning system may use the resource analyzer 16b to optimize the project plan in terms of resource use by determining if there is conflicting resource use between tasks and visually indicating this in the project plan. A user can indicate whether a task requires any resources. The resource analyzer determines whether there is conflicting resource use in the plan based on the dates of the tasks and the resources the tasks require. If there is conflicting resource use, a resource conflict error is visually displayed by the plan editor. For example, a human resource (e.g., Max) is input as a resource in the database. A limit can be set on the use of the resource, for example a percent of time for a human resource. The resource is input as a required resource for one or more tasks in the project plan, along with the usage of that resource, for example a percentage of time for a human resource. The resource and its usage for each task are stored as task properties in the database. To analyze any resource conflict in the project plan, the resource analyzer executes a resource calculation as follows:
1. The plan timeline from the earliest task start date to the plan's end date is split into intervals, and each task start date and task end date begins a new interval.
2. For a given interval, the usage values of resources of tasks which the date period intersects the given interval are summed.
3. For the given interval, if the sum of the resource is greater than the limit of the resource, the interval is appended to the list of conflicting intervals.
4. The user interface is notified that the list of resource conflict intervals has been updated in the analyzer.
5. If a period in the timeline intersects any of the resource conflict intervals, a visual indicator of a resource conflict error is displayed in the user interface. One example of a resource conflict error indicator 72 is shown in FIG. 12, wherein the time periods where there are resource conflicts are displayed in a different color (e.g. red).

The resource conflict calculation can be turned on by a user, i.e., a user chooses to run conflict detection. When it is turned on it is run automatically anytime there is change in a resource, which includes moving a task that uses a resource (i.e. changing the task start date or end date), adding or changing usage of a resource to a task, adding a new resource to the plan, and adding or changing a resource limit in the plan.

### Deliverables

In building the project plan, one or more deliverables can be added to the plan, and associated with one or more tasks. When a task is associated with a deliverable, this may be indicated in the plan editor. For example, in FIG. 11, the deliverable “IT” or “Training” is displayed as text in the task graphic. The deliverables may also be indicated visually, for example by assigning a color to each deliverable, and displaying that color on the task graphic that includes that deliverable. There may be different representations of the task graphic based on the zoom level of the plan editor. For example, if the plan is zoomed out to a certain threshold, the text in the task graphic boxes may be eliminated and only a color shown for the task graphic.

### Constraints

A task can include a time constraint which affects the start and/or end date of a task. The system prepares and optimizes the project plan taking into consideration all the time constraints on tasks. For example, if a task has a time constraint of “as soon as possible” (ASAP), the plan editor automatically runs a calculation to determine if the task start date can be earlier without creating a time conflict with any dependent tasks, i.e., it determines if there is any float between the task and all of its predecessor tasks. If the answer is yes, the start date for the task is updated to the earliest possible start date in the database and the plan editor moves the task graphic in the timeline to the earliest possible start date.

If a task has a time constraint of “as late as possible” (ALAP), the plan editor automatically runs a calculation to determine if the task end date can be later without creating a time conflict with any dependent tasks, i.e., it determines if there is any float between the task and all its successor tasks. If the answer is yes, the end date for the task is updated to the latest possible end date in the database and the plan editor moves the task graphic in the timeline to the latest possible end date.

A task can have a time constraint around a specific date, such as: start no earlier than, start no later than, end no later than, end no earlier than, start on date, and end on date. In this case, the plan editor automatically runs a calculation to determine if the task end date or start date agrees with the constraint. If the answer is no, the plan editor adds a visual constraint error indicator to the task. Alternatively, or in addition, the plan editor modifies the task end date and start date to agree with the constraint and moves the task to the new position in the timeline. For example, if a task has the time constraint of “start on Sept. 4”, the plan editor modifies the task start date to be September 4, calculates the new task end date based on task duration, and moves the task graphic in the timeline so the task graphic start position is on September 4. The update of the task start date and end date will have a cascade effect to cause other calculations to be run, including a determination if the change creates any time conflicts with dependent tasks, as described previously.

If a task has a time constraint, the plan editor may prevent a user from moving the task in the user interface to a position having a start date and/or end date that causes it to be inconsistent with the time constraint.

The constraint calculations may be prompted to run whenever a task property is added or changed in the database and whenever a constraint is added or modified for a task.

### Cost Analyzer

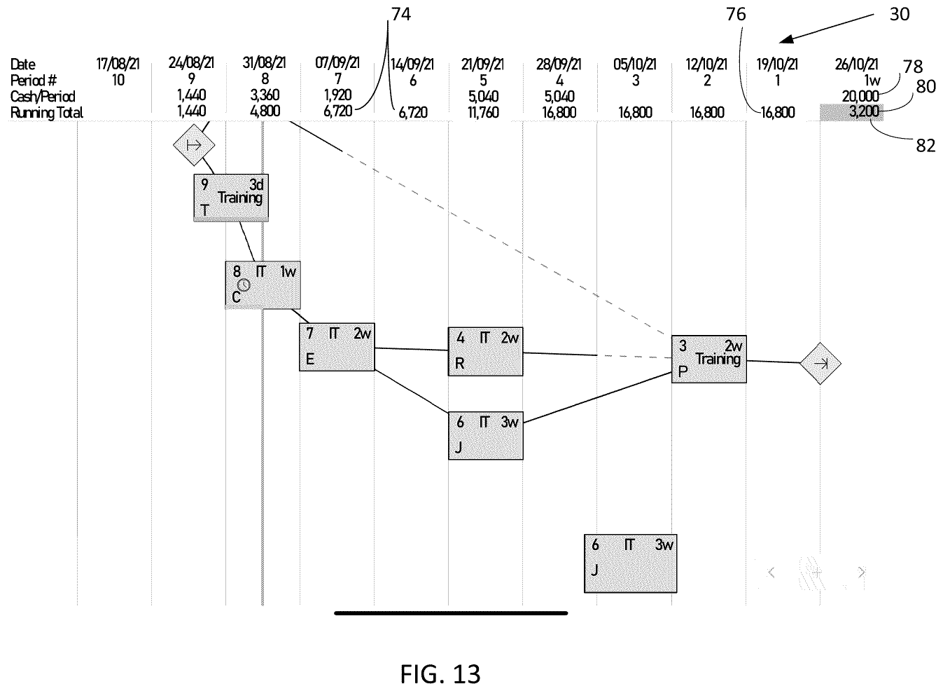

The project plan may be prepared and optimized by automatically calculating costs for the plan, calculating a running total of costs for each time interval in the plan, and comparing the total cost at the project end date to a budget. These calculations are performed with the cost analyzer 16a. The cost analyzer may determine if the total cost is equal to or less than the budget. If yes, a positive cost graphic indicator may be visually displayed in the user interface by the plan editor. If no, a negative cost graphic indicator may be visually displayed. FIG. 13 illustrates one example of the user interface indicating cost information, including the running total cost 74 for each time interval; the end date total cost 76, the budget 78, and the difference 80 between the budget and the end date total cost. In this case, the difference 80 is positive, meaning the project plan is under budget, so a positive graphic indicator 82 is added to the user interface, which in this case the use of a specific color around the cost difference 80. If the difference 80 was negative, meaning the project plan is over budget, a negative graphic indicator would be added to the user interface, for example a different color.

The cost calculations for each interval are determined by the cost analyzer by adding up the costs for each task in the interval period. The costs associated with each task include costs associated with the resource use for the task, which may be a fixed cost, a per hour cost, or a cost per use. Changing the task properties, including the task start date, end date, resource usage or resource rate, causes the cost for a task to be recalculated and updated, which automatically triggers the running totals, total cost and cost difference compared to the budget to be updated. Changing a task property may include, for example, changing a task duration, which may increase the task cost if there is a resource associated with the task having a cost per hour. In another example, if a task property is updated to add a resource, such as a piece of equipment having a cost per use, the task cost is updated to include the cost for use of the equipment

The automatic cost calculations allow a user to optimize the project plan, since the user can see in real-time the effect on project cost of moving a task in the project plan.

### Critical Path Analyzer

The critical path analyzer 16c determines the critical path in the project plan, which is the path between dependent tasks from the project start date to the project end date that has the least amount of float. There can be multiple critical paths in a project plan. The critical path analyzer determines which tasks and dependency links are part of the critical path, and the plan editor visually displays a critical path indicator, which may be on the dependency links and/or tasks. Any time a change is made to a task property, such as task start date, task end date, a change in a connection of a task dependency link or the task dependency type, the critical path analyzer runs its analysis to determine the critical path(s) and the plan editor updates the critical path indicators. The critical path analyzer helps optimize the project plan because it automatically displays to a user in real-time how modifications to the project plan change the critical path.

The critical path analyzer may dynamically analyze and update the one or more critical paths in the project plan as the dateline advances. This means as a project plan is carried out, the critical path may be determined as of the current date.

### Plan Optimization & Risk Analysis

Once a plan is prepared, a user can edit task properties to see how various changes affect the plan properties such as plan start, plan end date and total project cost. A user can input alternative scenarios to evaluate risk. For example, a user can quickly determine how a certain task being delayed by two weeks affects the plan. To do so, a user changes the task duration to add two weeks, and the plan automatically updates to indicate any changes in time conflicts, budget, resource conflicts and critical path. The user can move one or more affected tasks to clear any time and resource conflicts, or the plan can automatically move the tasks to clear any conflicts. The user can then see immediately the effect that the change in task duration had in terms of timing for various tasks as well as the overall project end date and budget. The user can make the edits in the main project plan, or they can duplicate the main project plan to create an alternative plan that they edit, leaving the original plan intact for comparison purposes.

### Project Plan Repair

In some embodiments, a project plan prepared in a different computer application can be imported into the subject computer application for testing, editing and optimization. For example, the tasks in a Gantt chart from a plan created in another computer application (e.g., Microsoft® Project, Primavera™) can be imported into the project plan described herein, including the task start dates, task end dates, task dependencies, and task duration. The imported plan data is run through the various analyzers to determine and display any time conflicts and/or resource conflicts. The plan can then be changed automatically and/or by the user to clear the conflicts, thus “repairing” the plan. In an imported plan, the analyzers can also determine if constraints associated with tasks are being met. For example, if a task has a constraint of a start date being “as soon as possible”, the analyzers can determine and indicate if this constraint is being met or if the task can be moved earlier based on available float. The constraint may be imported from another plan, or it may be added by a user after the plan is imported. In addition, the imported plan can be run through the cost analyzer and/or the critical path analyzer. It can also go through the automated plan verification procedure outlined below.

A plan prepared and optimized with the subject computer application can also be exported for use with another computer application.

### Automated Plan Verification

In some embodiments, the subject system includes an automated plan verifier which prompts verification of the plan at various checkpoints as the plan is prepared. When a task is added to the plan, and a user advances the plan toward the start date using the plan editor, a verification prompt may be triggered such that the predecessor tasks must be verified before a user can continue adding tasks to the project plan. For example, when a user selects the advance button 64, the plan editor displays a list of all the predecessor tasks of the active task and provides a choice: yes or no, asking the user to verify the dependency links between the predecessor task and the active task. If yes is selected, the active task indicator moves to the next task. If no is selected, the active task indicator does not move to the next task, but remains on the current active task to allow the user to make updates to the active task and its predecessor tasks if needed. The verification prompt can also include an audio prompt, where each predecessor task is read aloud to the user using a text-to-speech converter in the computer system.

Although the present disclosure has been described and illustrated with respect to certain embodiments and preferred uses thereof, it is not to be so limited since modifications and changes can be made therein which are within the full, intended scope of the disclosure as understood by those skilled in the art.

1. A method for preparing and optimizing a project plan comprising the steps:
providing a display having a project timeline and a project end date graphic on the timeline at a project plan end date;
inputting a first task and a first task duration;
dynamically calculating a first task start date and a first task end date based on the first task duration and the project plan end date and displaying a first task graphic on the project timeline at the first task start date;
inputting a second task and a second task duration, wherein the second task is dependent on the first task;
dynamically calculating a second task start date and a second task end date based on the second task duration and the first task start date and/or the first task end date, and displaying a second task graphic on the project timeline at the second task start date;
dynamically re-calculating the project plan start date equal to an earlier of the first task start date and the second task start date, and displaying the project plan start date graphic on the project timeline at the re-calculated project plan start date;
wherein the first and second task are collectively referred to as dependent tasks comprising a successor task and a predecessor task; and
dynamically displaying a dependent task linking graphic connecting the first task graphic and the second task graphic, wherein the dependent task linking graphic indicates task duration of the predecessor task and any float between the dependent tasks.

2. The method of claim 1, wherein each task graphic has a task graphic start position in the project timeline representing the task start date, and a task graphic end position that is a predetermined distance from the task graphic start position regardless of the task end date, wherein the predetermined distance is the same for each task graphic.

3. The method of claim 2, further comprising:
determining whether the predecessor task end date is later than the predecessor task graphic end position;
determining whether the successor task graphic start position is later than the predecessor task end date;
if yes to both of the above, displaying the dependent task linking graphic in the project timeline between the first task graphic and the second task graphic as:
a first segment having a first style between the predecessor task graphic end position and the predecessor task end date to represent the predecessor task duration, and
a second segment having a second style between the predecessor task end date and the successor task graphic start position to represent the float between the dependent tasks.

4. The method of claim 1, further comprising for dependent tasks, dynamically calculating and displaying whether there is a time conflict between the end date and/or the start date of the dependent tasks.

5. The method of claim 1, further comprising:
in response to a user moving one of the task graphics in the project timeline to a new position:
dynamically calculating a new start date and a new end date for the moved task;
dynamically calculating whether there is a time conflict between the new start end date, the new start date, and any other tasks that are dependent tasks with the moved task;
if there is a time conflict, dynamically moving the moved task graphic back to its previous position where there was no time conflict; and
if there is no time conflict, displaying the moved task graphic at the new start date.

6. The method of claim 1, further comprising:
in response to a user updating a task start date from an original start date to a proposed start date, dynamically calculating whether the proposed start date creates any time conflicts between dependent tasks, and if yes, updating task start dates for dependent tasks to prevent time conflicts and displaying the task graphics at the updated task start dates.

7. The method of claim 1, further comprising:
in response to a user moving a predecessor task graphic or a successor task graphic in the timeline, dynamically calculating any change in float between the dependent tasks and displaying the changed float in the dependent task linking graphic.

8. The method of claim 1, further comprising:
in response to a user adding or editing a resource needed to implement the project plan and associating the resource with one or more of the tasks, calculating any conflicts in use of the resource for each time interval in the project timeline and displaying any calculated resource conflicts.

9. The method of claim 1, further comprising:
in response to a user performing a trigger action, prompting the user to verify dependencies between dependent tasks.

10. The method of claim 1, wherein in response to a user inputting a budget and a cost associated with each task, calculating and displaying a running total of the budget in the timeline, and wherein in response to a user adding, deleting, editing or moving a task in the timeline, dynamically updating the running and comparing it to a budget.

11. The method of claim 1, wherein after the first task is input, one or more predecessor tasks dependent on the first task are suggested and displayed to a user based on a database of possible tasks.

12. The method of claim 11, wherein an artificial intelligence (AI) system determines the one or more suggested predecessor tasks.

13. The method of claim 11, wherein upon a user accepting at least one of the one or more suggested predecessor tasks, the at least one accepted task is input as the second task.

14. A method for analyzing and optimizing an existing project plan, comprising;
providing a display having a project timeline;
inputting a plurality of tasks and task properties from the existing project plan into the timeline, wherein at least some of the tasks are dependent tasks comprising predecessor tasks and successor tasks, and wherein the task properties comprise task duration, task start date, task end date, and task dependencies;
displaying each task on the timeline with a task graphic located at the task start date;
displaying linking graphics between dependent tasks, wherein the linking graphics display the task duration of the predecessor task and any float between the dependent tasks; and
calculating whether there are any time conflicts between the dependent tasks and displaying any time conflicts.

15. The method of claim 14, further comprising:
calculating new task start dates and end dates for the plurality of tasks to clear any time conflicts and displaying the task graphics at the new start dates; and
calculating and displaying any changes in the linking graphics between dependent tasks.

16. A system for preparing and optimizing a project plan comprising:
a memory comprising a database for storing data;
a display configured to display a project timeline and a project end date graphic positioned at a project end date on the project timeline;
a graphical user interface controller configured to allow a user to input data; and
a processor configured to:
in response to a user inputting a first task and a first task duration with the graphical user interface controller:
dynamically calculating a first task start date and a first task end date based on the first task duration and the project plan end date and displaying a first task graphic on the project timeline at the first task start date;
in response to the user inputting a second task and a second task duration with the graphical user interface controller, wherein the second task is dependent on the first task;
dynamically calculating a second task start date and a second task end date based on the second task duration and the first task start date and/or the first task end date, and displaying a second task graphic on the project timeline at the second task start date;
dynamically re-calculating the project plan start date equal to an earlier of the first task start date and the second task start date, and displaying the project plan start date graphic on the project timeline at the re-calculated project plan start date;
wherein the first and second task are collectively referred to as dependent tasks comprising a successor task and a predecessor task; and
dynamically displaying a dependent task linking graphic connecting the first task graphic and the second task graphic, wherein the dependent task linking graphic indicates task duration of the predecessor task and any float between the dependent tasks.

17. The system of claim 16, wherein each task graphic has a task graphic start position in the project timeline representing the task start date, and a task graphic end position that is a predetermined distance from the task graphic start position regardless of the task end date, wherein the predetermined distance is the same for each task graphic.

18. The system of claim 17, wherein the processor is further configured for:
determining whether the predecessor task end date is later than the predecessor task graphic end position;
determining whether the successor task graphic start position is later than the predecessor task end date;
if yes to both of the above, displaying the dependent task linking graphic in the project timeline between the first task graphic and the second task graphic as:
a first segment having a first style between the predecessor task graphic end position and the predecessor task end date to represent the predecessor task duration, and
a second segment having a second style between the predecessor task end date and the successor task graphic start position to represent the float between the dependent tasks.

19. The system of claim 13, wherein the processor is further configured:
for dependent tasks, dynamically calculating and displaying whether there is a time conflict between the end date and/or the start date of the dependent tasks.

20. The system of claim 16, wherein the processor is further configured for:
in response to a user moving one of the task graphics in the project timeline to a new position with the graphical user interface controller:
dynamically calculating a new start date and a new end date for the moved task;
dynamically calculating whether there is a time conflict between the new start end date, the new start date, and any other tasks that are dependent tasks with the moved task;
if there is a time conflict, dynamically moving the moved task graphic back to its previous position where there was no time conflict; and
if there is no time conflict, displaying the moved task graphic at the new start date.

21. The system of claim 16, wherein the processor is further configured for:
in response to a user updating a task start date from an original start date to a proposed start date with the graphical user interface controller, dynamically calculating whether the proposed start date creates any time conflicts between dependent tasks, and if yes, updating task start dates for dependent tasks to prevent time conflicts and displaying the task graphics at the updated task start dates.

22. The system of claim 16, wherein the processor is further configured for:
in response to a user moving a predecessor task graphic or a successor task graphic in the timeline with the graphical user interface controller, dynamically calculating any change in float between the dependent tasks and displaying the changed float in the dependent task linking graphic.

23. The system of claim 16, wherein the processor is further configured for:
in response to a user adding or editing a resource needed to implement the project plan and associating the resource with one or more of the tasks with the graphical user interface controller, calculating any conflicts in use of the resource for each time interval in the project timeline and displaying any calculated resource conflicts.

24. The system of claim 16, wherein the processor is further configured for:
in response to a user performing a trigger action with the graphical user interface controller, prompting the user to verify dependencies between dependent tasks.

25. The system of claim 16, wherein the processor is further configured for:
in response to a user inputting a budget and a cost associated with each task with the graphical user interface controller, calculating and displaying a running total of the budget in the timeline, and
in response to a user adding, deleting, editing or moving a task in the timeline with the graphical user interface controller, dynamically updating the running and comparing it to a budget.

26. The system of claim 16, wherein the processor is further configured to:
after the first task is input, suggest and display one or more predecessor tasks dependent on the first task based on a database of possible tasks.

27. The system of claim 26, wherein an artificial intelligence (AI) system determines the one or more suggested predecessor tasks.

28. The system of claim 26, wherein the processor is further configured to:
upon a user accepting at least one of the one or more suggested predecessor tasks, inputting the at least one accepted task as the second task.

29. A system for analyzing and optimizing an existing project plan, comprising;
a memory comprising a database for storing data;
a display configured to display a project timeline;
a graphical user interface controller configured to allow a user to input data; and
a processor configured to:
in response to a user inputting a plurality of tasks and task properties from the existing project plan into the timeline, wherein at least some of the tasks are dependent tasks comprising predecessor tasks and successor tasks, and wherein the task properties comprise task duration, task start date, task end date, and task dependencies:
displaying each task on the timeline with a task graphic located at the task start date;
displaying linking graphics between dependent tasks, wherein the linking graphics display the task duration of the predecessor task and any float between the dependent tasks; and
calculating whether there are any time conflicts between the dependent tasks and displaying any time conflicts.

30. The system of claim 29, wherein the processor is further configured for:
calculating new task start dates and end dates for the plurality of tasks to clear any time conflicts and displaying the task graphics at the new start dates; and
calculating and displaying any changes in the linking graphics between dependent tasks.
